(19) United States
(12) Patent Application Publication
(10) Pub. No.: US 2008/0261195 A1
(43) Pub. Date: Oct. 23, 2008

(54) Written examination system and written examination device

(75) Inventor: Toshifumi Kanamaru, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD, Tokyo (JP)

(21) Appl. No.: 12/068,910

(22) Filed: Feb. 13, 2008

(30) Foreign Application Priority Data
Apr. 18, 2007 (JP) JP2007-109400

(51) Int. Cl. G09B 7/00

(52) U.S. Cl. 434/362

(57) ABSTRACT

There is provided a written examination system in which paper consumption and flowing out of examination questions in a written examination may be prevented. The written examination system according to the present invention comprises: a display device 12 used by each examinee taking a written examination; and an information processing device 16 providing examination question data to the display device 12. The display device 12 includes: a display part 124 including electronic paper on which examination question data is displayed; a receiving part 121 receiving the examination question data from the information processing device 16; and a display control part 123 controlling the display state of the examination question data on the display part 124. The information processing device 16 includes: a question data storing part 163 storing the examination question data; and a transmission control part 162 controlling transmission of the examination question data to the display device 12.

### CROSS-REFERENCE TO RELATED APPLICATION

The disclosure of Japanese Patent Application No. JP2007-109400, filed Apr. 18, 2007, entitled “Written examination system, and Written examination device”. The contents of that application are incorporated herein by reference in their entirety.

### BACKGROUND OF THE INVENTION

1. Field of the Invention

The present invention relates to a written examination system, and a written examination device.

2. Description of the Related Art

Various kinds of examination systems have been invented so far in order to reduce labor and time required for examinations, evaluations of examination results, and the like. The above examination refers to testing in which questions are answered and actual performances are conducted in order to judge person's achievement, knowledge, abilities, and the like.

For example, Japanese Patent Application Laid-Open No. 2001-290412 (Patent Document 1) has disclosed an automatic examination system in which practical examinations or written examinations may be performed, and pass/fail judgements may be conducted on the spot in a booth at any time. In the above system, a personal identification document is confirmed by a document and image camera, practical examinations are conducted using a video conferencing system, written examinations are performed using a page printer and a document and image camera, and multiple-choice examinations may be performed using a monitor with a touch panel.

However, question sheets and answer sheets are printed for written examinations in the system described in Japanese Patent Application Laid-Open No. 2001-290412, and there has been a problem that paper is consumed, and a question sheet is taken out from a examination site. Though various forms of examinations may be performed by one system, there has been another problem that the number of equipment becomes large, and complex management is required as different kinds of equipment are required to be used depending on the kinds of the examinations such as a multiple-choice examination, and a written examination.

### SUMMARY OF THE INVENTION

Then, the present invention has been made, considering the above-described problems, and an object of the present invention is to provide a new and improved written examination system, and a written examination device for the system, wherein paper consumption in written examinations, and examination questions may be prevented from flowing out according to the device and the system.

In order to solve the above-described problem, there is a written examination system according to an aspect of the present invention, wherein the system comprises a display device used by each examinee taking a written examination, and an information processing device providing examination question data to the display device. The above-described display device includes: a display part including electronic paper on which examination question data is displayed; a receiving part for receiving the examination question data transmitted from the information processing device; and a display control part for displaying the examination question data received by the receiving part on the display part, and controlling the display state of the display part. Moreover, the above-described information processing device includes: a question data storing part for storing the examination question data; and a transmission control part for reading out the examination question data from the question data storing part, and controlling transmission of the examination question data to the display device.

By the above configuration, the display device is used only for display of, mainly, examination questions, data for examination questions to be displayed may be provided from the information processing device such as a server. Thereby, an answer sheet including an examination question may be prevented from being taken out, because data for examination questions is not included in display devices distributed to the examinees. Moreover, the display device is only required to be provided with a display function, so that a manufacturing cost of a display device may be suppressed, wherein the number of the display devices is required to be the same with that of examinees. Moreover, the electronic paper is used for the display device, so that the electric power consumption may be reduced.

Moreover, the transmission control part may count elapsed time after examination question data is transmitted to the display device, and, read out examination question data different from the examination question data under displaying from the question data storing part and transmit to the display device, when the elapsed time exceeds a predetermined value. Thereby, an examination question may be transmitted to examinees every predetermined time, and there may be limited answering time for each question may be limited.

Moreover, the display device may further include an external signal input part into which an external signal for changing a display state of the display device is input, and the display control part may display examination question data, which is different from the examination question data under displaying, on the display part according to the external signal input from the external signal input part. Thereby, an examinee may change an examination question for display by performing a predetermined operation, and each of examinees may answer questions at own pace.

Moreover, the transmission control part may transmit a signal for erasing the display of the examination question data to the display device at predetermined time. Thereby, for example, questions are erased at the same time as an examination is completed in such a way that examinees may not answer the questions thereafter, and, at the same time, the examination questions may be prevented from flowing out.

Moreover, the display control part may erase the display of the display part according to the external signal input from the external signal input part. Thereby, the display of an examination question may be erased by operation of an examinee.

Furthermore, the written examination system may further comprise an answer input device used for input of answer data indicating the contents answered by an examinee, and the display device may receive the answer data input by the answer input device, and the answer data is displayed on the display part. Thereby, an examinee may confirm the contents has been answered by the examinee on the display part.

Moreover, the information processing device may further include: a receiving part for receiving the answer data input by the answer input device; a character recognition part for performing character recognition processing of the answer data received by the receiving part; and an answer storing part for storing the answer data for each of examinees. The character recognition part may store data, which includes characters recognized by the character recognition part, as answer data in the answer storing part. Thereby, for example, even when answer data input through the answer input device is written data by hand writing and the like, data converted into text data by character recognition processing may be stored or transmitted as answer data.

In order to solve the above-described problem, there is provided a written examination device according to another aspect of the present invention, wherein a written examination device used by each of examinees taking a written examination comprises: a question data storing part for storing examination question data; a display part including electronic paper on which the examination question data is displayed; and a display control part for reading out examination question data from the question data storing part, displaying the examination question data on the display part, and controlling the display state of the display part.

According to the above configuration, examination questions may be provided to examinees by a simple configuration eliminating a server and the like. Communication is not required when examination questions are rewritten, so that time required for communication may be shortened, and a configuration in the device may be simplified.

Moreover, the display control part may count elapsed time after an arbitrary piece of the examination question data is displayed on the display part, and, read out the examination question data different from examination question data under displaying from the question data storing part and display on the display part when the elapsed time exceeds a predetermined value. Thereby, examination questions may be transmitted to examinees every predetermined time, and answering time for each of questions may be limited.

Moreover, the written examination device may further comprise an external signal input part into which an external signal for changing the display state of the display part is input, and, the display control part may read out the examination question data different from the examination question data under displaying from the question data storing part, and display on the display part, according to the external signal input from the external signal input part. Thereby, when an examinee performs a predetermined operation, an examination question to be displayed may be changed, and each examinee may answer questions at own pace.

Moreover, the display control part may erase the display of the display part at predetermined time. Thereby, for example, questions are erased at the same time as an examination is completed in such a way that examinees may not answer the questions thereafter, and, at the same time, examination questions may be prevented from flowing out.

Moreover, the display control part may erase the display of the display part according to the external signal input from the external signal input part. Thereby, the display of an examination question may be erased by operation of an examinee.

Moreover, the written examination device may further comprise an answer input part into which answer data indicating the contents answered by an examinee is input, and the answer storing part for storing answer data input from the answer input part for each of the examinees, and the display control part may display the answer data input from the answer input part on the display part. Thereby, an examinee may confirm the contents, which the examinee has answered, on the display part.

Moreover, the written examination device may further comprise a character recognition part for performing character recognition processing of the answer data input into the answer input part, and the character recognition part may store data including characters recognized by the character recognition part as answer data in the answer storing part. Thereby, for example, even when answer data input through the answer input device is written data by handwriting and the like, data converted into text data by character recognition processing may be stored or transmitted as answer data.

As explained above, consumption of paper and flowing out of examination questions in a written examination may be prevented according to the present invention.

### BRIEF DESCRIPTION OF THE DRAWINGS

FIG. 1 is a view showing a schematic configuration of a written examination system according to a first embodiment;

FIG. 2 is a block diagram showing a schematic configuration of a display device according to the first embodiment;

FIG. 3 is a block diagram showing a schematic configuration of a examination server according to the first embodiment;

FIG. 4 is a flow diagram showing a processing flow in the written examination system according to the first embodiment; and

FIG. 5 is a block diagram showing a schematic configuration of a written examination system according to a second embodiment.

### DETAILED DESCRIPTION OF THE PREFERRED EMBODIMENTS

Hereinafter, preferred embodiments according to the present invention will be explained in detail referring to attached drawings. Here, components with a substantially similar functional configuration to those in the present description and the drawings are denoted by the same reference numerals, and repeated description will be omitted.

### First Embodiment

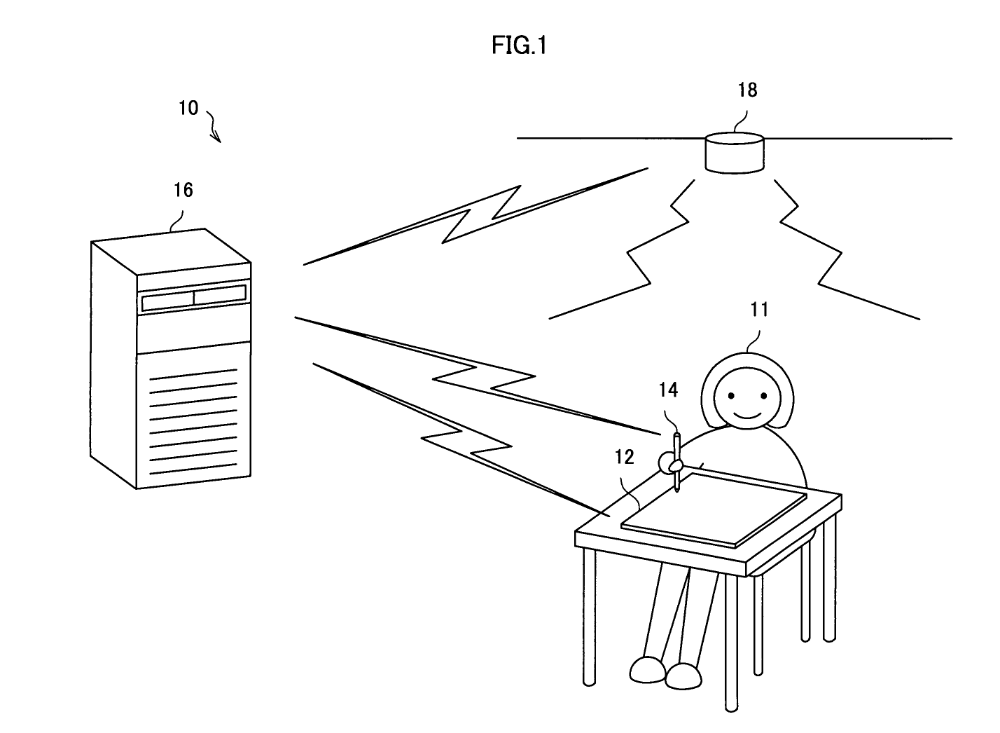

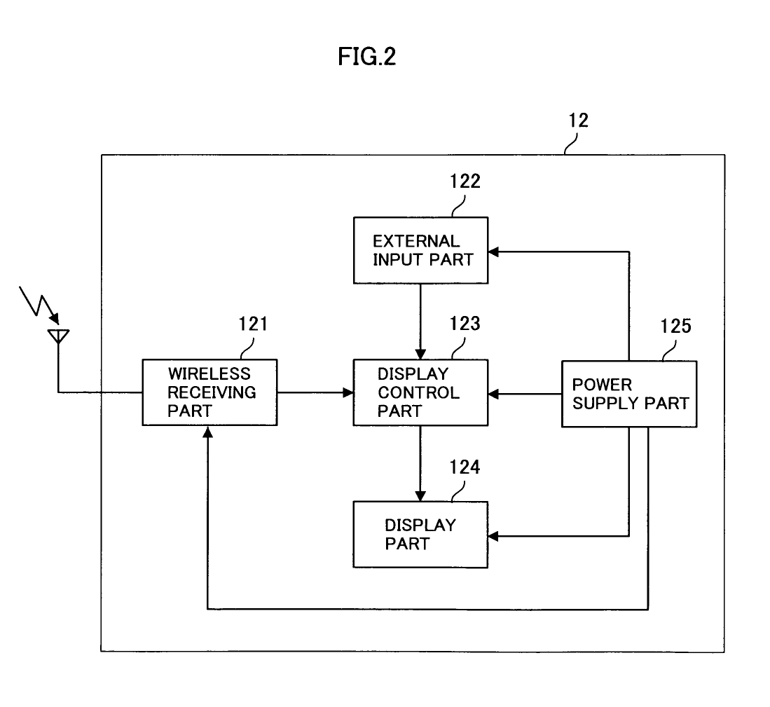

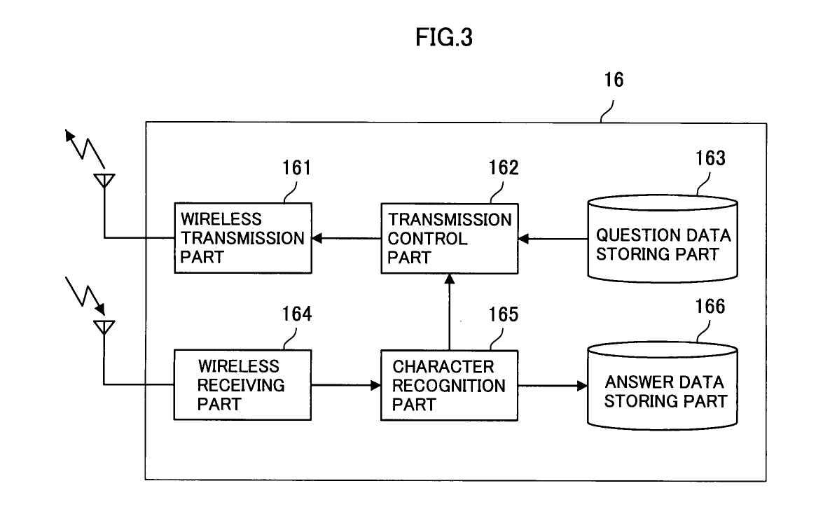

First, a configuration of a written examination system according to a first embodiment of the present invention will be explained based on FIG. 1 through FIG. 3. Here, FIG. 1 is a block diagram showing a schematic configuration of a written examination system 10 according to the first embodiment. Moreover, FIG. 2 is a block diagram showing a schematic configuration of a display device 12 in the written examination system 10, and FIG. 3 is a block diagram showing a schematic configuration of an examination server 16 in the written examination system 10.

As shown in FIG. 1, the written examination system 10 according to the first embodiment includes: a display device 12; an input device 14; and an examination server 16. Moreover, the written examination system 10 may include a relay device 18, which relays data transmitting and receiving between the examination server 16 and the display device 12, and between the examination server 16 and the input device 14 according to demand. Here, the examination server 16 is one example of an information processing device according to the present invention.

According to the first embodiment, an examination question is displayed on the display device 12 distributed to each of examinees 11, and the examination server 16 provides data on examination questions and controls display on the display device 12. Moreover, answers may be input by using the input device 14 distributed to each of examinees 11, and answered contents may be displayed on the display device 12.

Here, in the present embodiment, a display using electronic paper will be explained as a display displaying data on the display device 12. The above-described electronic paper refers to a display which is a thin reflection-type panel without using a back light, and, by which, even if a voltage is not applied to each of pixels, a same image may be kept being displayed for a long time.

(Display Device 12)

First, the configuration of the display device 12 will be explained. The display device 12 is distributed to each of examinees 11, and has a function by which examination questions are provided to examinees 11 using a display including electronic paper. Moreover, the display device 12 also has a function by which an input answer is displayed on the display by operating the input device 14 by an examinee.

The display device 12 includes, as shown in FIG. 2: a wireless receiving part 121; an external input part 122; a display control part 123; a display part 124; and a power supply part 125. Hereinafter, each part in the display device 12 will be explained.

(Wireless Receiving Part 121)

The wireless receiving part 121 receives a wireless signal which includes question data transmitted from the examination server 16 and a signal which controls the display state of the display part 124. The wireless receiving part 121 conducts predetermined processing of a wireless signal received from the examination server 16. The predetermined processing means amplification, frequency conversion and the like. Thereafter, the processed wireless signal is converted to a digital signal by analog to digital conversion for input to the display control part 123. Moreover, the wireless receiving part 121 may receive a wireless signal transmitted from the input device 14, and input a digital signal to the display control part 123 through similar signal processing.

Furthermore, the wireless receiving part 121 may be configured to receive a wireless signal transmitted from the examination server 16, or the input device 14 through the relay device 18 separately provided. The relay device 18 may be, for example, an antenna and the like which are installed on a wall, a ceiling and the like in a hall in which an examinee 11 takes an examination.

(External Input Part 122)

The external input part 122 is input a demand signal for changing or erasing display contents of the display device 12. For example, an examinee 11 using the display device 12 to take an examination operates an input interface (not shown) such as keys, buttons, and switches provided in the display device 12, and a predetermined signal is input to the external input part 122. The input signal is transmitted to the display control part 123, and the display control part 123 executes contents demanded by the input signal. Alternatively, there may be provided a configuration in which a transmission part, which transmits a predetermined signal to the examination server 16, is separately provided, and a predetermined demand signal is transmitted to the examination server 16 based on the input signal.

Thereby, for example, when an examinee 11 operates a button and the like for instruction to rewrite an examination question to be displayed on the display part 124 to the next question, a demand signal for display rewriting is input to the external input part 122, and the demand is transmitted from the external input part 122 to the display control part 123, or the examination server 16 to rewrite display on the display part 124.

(Display Control Part 123)

The display control part 123 controls a display state of the display part 124. The display control part 123 displays question data received from the wireless receiving part 121 on the display part 124, and rewrites display of the display part 124 according to the question data newly received. Moreover, the display control part 123 erases display of the display part 124 according to a signal received by the wireless receiving part 121. Furthermore, there may be provided a configuration in which the display control part 123 rewrites a part of, or all of the contents displayed on the display part 124 based on the answer data received from the wireless receiving part 121, and an answer input by the input device 14 is displayed on the display part 124.

Moreover, the display control part 123 may control the display state of the display part 124 according to the signal input from an external input part 122. For example, when a predetermined signal is input by the external input part 122, the display control part 123 may display question data on the display part 124, or erase the display. At this time, a signal demanding question data is transmitted to the examination server 16 according to input from the external input part 122, and the question data is transmitted. Alternatively, there may be provided a configuration in which a buffer storing question data received from the wireless receiving part 121 is provided in the display device 12, and, according to the input from the external input part 122, the display control part 123 may display question data stored in the buffer on the display part 124.

Moreover, the display control part 123 may be provided to internally include a timer for managing time, and to control the display state of the display part 124 according to the time counted by the timer. For example, when it is detected by the timer that it is time for starting an examination, the display control part 123 may display the question data stored in the buffer on the display part 124. Alternatively, when it is time for terminating an examination, the display control part 123 may erase the display. Alternatively, there may be provided a configuration in which elapsed time is counted by the timer after starting display of a certain question data, and, when the elapsed time exceeds a predetermined time, the display control part 123 may rewrite the display to the next question data.

(Display Part 124)

The display part 124 is a display which displays examination questions. In the present embodiment, the display part 124 includes electronic paper. Along with start of an examination, a part of, or all of examination questions are displayed on the display part 124, and the display is erased after terminating the examination. When only a part of examination questions are displayed, the display is sequentially rewritten at a predetermined time interval after starting the examination to display of another question. Alternatively, there may be provided a configuration in which an examinee 11 performs input operation, using the external input part 122, for rewriting and erasing of the display. Display, display rewriting, and display erasing of examination questions are controlled by the display control part 123.

Moreover, the display part 124 may also display an answer input by an examinee 11 using the input device 14, together with examination questions. Alternatively, there may be provided a configuration in which a display part for display of questions, and a display part for display of answers are separately provided.

(Power Supply Part 125)

The power supply part 125 supplies power for operating parts in the display device 12 to the parts. The power supply part 125 is configured to switch ON/OFF of a power supply to parts in the display device 12 for example, by sensing ON/OFF of a power supply button (not shown) provided on the display device 12. Moreover, there may be provided a configuration in which power supply to the display part 124 is performed when the display is rewritten, and, power supply is cut till the next display rewriting after display is rewritten once.

The display device 12 has been explained as described above. Here, parts in the display device 12 may be configured by software including program modules which may execute the above described functions and are installed in the information processing device such as computers, or by hardware such as processors which may execute the above-described functions.

(Input Device 14)

Subsequently, the input device 14 will be explained. The input devices 14, as well as the display devices 12, are distributed to each of examinees 11, and are used in such a way that the examinees 11 input answers. In the present embodiment, the input device 14 will be explained, for example, as a pen type device as shown in FIG. 1. The input device 14 may include: a camera which takes in information on traces of a pen point as an image; a memory which memorize information on tracks and memo time, and the like, which are taken in by the camera; a wireless communication unit which transmit information memorized in the memory using wireless communication; and the like.

Operations of the input device 14 in the above case will be explained as follows: when an examinee 11 writes an answer on an electronic paper (display part 124) on the display device 12 using a pen, the pen tracks are read by a camera provided in the input device 14, and data which have recorded the tracks is transmitted to the examination server 16 through the wireless communication unit. The examination server 16 may perform character recognition based on the received written data, and store the recognized result as answer data, or transmit the answer data to the display device 12. The display device 12 displays the answer data transmitted from the examination server 16 on the display. Thereby, an examinee may confirm the contents of the answer which the examinee has input using the input device 14.

Alternatively, the input device 14 may transmit image data directly to the display device 12. The display device 12 may process the image data received from the input device 14, and display the processed data on the display.

For example, a device described in a Non-Patent Document 1 (http://functionality.anoto.co.jp/cldoc/ajp24.htm) may be used as the above input device 14. In this case, a dot pattern is recognized using a camera image photographing a picture of pen point tracks by displaying a pattern with fine dots on an electronic paper (display part 124) on which answers are written, and the character recognition may be realized by using the recognized dot pattern. There may be provided a configuration in which the dot pattern displayed on the electronic paper is memorized in the examination server 16, and the answer data superimposing on the dot pattern is transmitted to the display device 12.

Here, even an input device other than the above-described example may be used as the input device 14, wherein the input device includes, for example, a keyboards, a mouse, a tablet, a touch panel and the like.

(Examination Server 16)

Subsequently, the examination server 16 will be explained. As shown in FIG. 3, the examination server 16 includes: a wireless transmission part 161; a transmission control part 162; a question data storing part 163; a wireless receiving part 164; a character recognition part 165; and an answer data storing part 166. Hereinafter, the above parts in the examination server 16 will be explained.

(Wireless Transmission Part 161)

The wireless transmission part 161 transmits question data and the like to the display device 12. The wireless transmission part 161 receives question data to be transmitted from the transmission control part 162, and a transmission timing and the like are controlled by the transmission control part 162. Moreover, the wireless transmission part 161 may transmit the question data to the display device 12 thorough the relay device 18.

Moreover, the wireless transmission part 161 may transmit an erasing signal for instructing the display device 12 to erase displayed questions. In this case, a signal may be transmitted to the display device 12 through the relay device 18. Moreover, there may be provided a device transmitting an erasing signal to the display device 12 in a separate manner. There may be provided, for example, a configuration in which there is provided a gate with a device transmitting an erasing signal at an exit and an entrance of the examination site, and, when the display device 12 passes through the gate, the gate transmits an erasing signal in such a way that examination questions displayed on the display device 12 are erased. Thereby, examination questions may be prevented from being taken out to the outside of an examination site, and, at the same time, it may be detected that the display device itself has been taken out from an examination site.

(Transmission Control Part 162)

The transmission control part 162 controls the wireless transmission part 161 to transmit an erasing signal for erasing question data and the display to the display device 12. The transmission control part 162 includes, for example, a timer for managing time, and controls the wireless transmission part 161 to transmit question data according to the time counted by the timer. For example, when it is notified by the timer that predetermined time has come, the transmission control part 162 may obtain question data from the question data storing part 163 to be displayed on the display part 124, or erase the display. Alternatively, there may be provided a configuration in which elapsed time is counted by the timer after starting display of certain question data, and, when the elapsed time exceeds a predetermined time, the display is rewritten to the display of the next question data.

Alternatively, the transmission control part 162 may be configured to control transmission of question data, or an erasing signal according to a predetermined signal received by the wireless receiving part 164. For example, when the wireless receiving part 164 receives a signal, which requires that a displayed question is rewritten from the display device 12, the transmission control part 162 may obtain the question data from the question data storing part 163, and transmit the obtained data to the display device 12 through the wireless transmission part 161. Alternatively, when the wireless receiving part 164 receives a signal, which requires that a displayed question is erased from the display device 12, the transmission control part 162 may transmit an erasing signal for erasing the displayed question to the display device 12 through the wireless transmission part 161.

Moreover, the transmission control part 162 may control to transmit answer data extracted in the character recognition part 165 to the display device 12. Alternatively, the transmission control part 162 may control to transmit the data received from the input device 14 by the wireless receiving part 164 to the display device 12. In this case, there may be provided a configuration in which data is transmitted from the wireless transmission part 161, responding to timing at which data is input from the character recognition part 165, and the wireless receiving part 164, or data is transmitted from the wireless transmission part 161 at a predetermined time interval.

(Question Data Storing Part 163)

The question data storing part 163 stores question data to be transmitted to the display device 12. The question data is transmitted to the display device 12 through the transmission control part 162 and the wireless transmission part 161.

(Wireless Receiving Part 164)

The wireless receiving part 164 receives various kinds of data transmitted from the display device 12 or the input device 14. The wireless receiving part 164 receives, for example, handwriting data transmitted from the input device 14, and inputs the data to the character recognition part 165. Alternatively, the wireless receiving part 164 may be configured to receive a predetermined signal transmitted from the display device 12 for input to the transmission control part 162. Here, the predetermined signal is for example, a signal of a demand for transmission of the following question data, and a signal demanding for erasing a display on the display part, and the like. Moreover, communication between the wireless receiving part 164 and the display device 12, or the wireless receiving part 164 and the input device 14 may be performed through the relay device 18.

(Character Recognition Part 165)

The character recognition part 165 performs character recognition processing of the handwriting data received from the input device 14 by the wireless receiving part 164, and extracts answer data of character data from the handwriting data. For example, in the case of the answer data obtained by recording tracks written by using the pen-type input device 14, the character recognition part 165 performs character recognition processing of the track data to extract answer data including recognized characters. The above-described character recognition processing may be performed by using a conventional character recognition processing technology.

The character recognition part 165 stores the extracted answer data in the answer data storing part 166 after the character recognition processing. Moreover, the answer data may be given to the transmission control part 162 for transmission to the display device 12 through the wireless transmission part 161.

(Answer Data Storing Part 166)

The answer data storing part 166 memorizes answer data extracted by the character recognition part 165. After terminating an examination, evaluations are performed using answer data stored in the answer data storing part 166.

As described above, the configuration of the examination server 16 has been explained. Here, the wireless transmission part 161, the transmission control part 162, the wireless receiving part 164, and the character recognition part 165 may be configured by software including program modules which may execute the above described functions and are installed in the information processing device such as computers, or by hardware such as processors which may execute the above-described functions. Moreover, the question data storing part 163 and the answer data storing part 166 may include various kinds of storage media such as a semiconductor memory, an optical disk, and a magnetic disk.

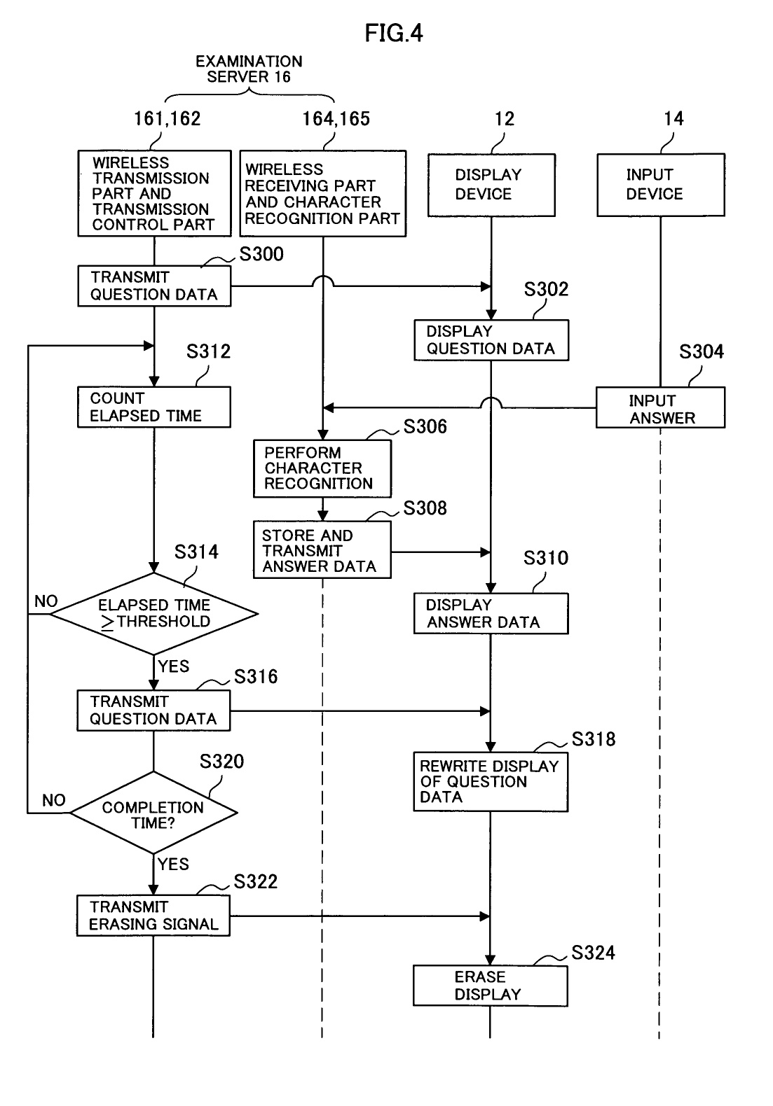

Subsequently, processing in the written examination system 10 according to the present embodiment will be explained referring to FIG. 4. FIG. 4 is a flow chart showing one example of a processing flow in the written examination system 10.

Here, there will be explained herein an examination, assuming that in the examination, a plurality of questions are answered, answering time for each question is determined beforehand, and, examination questions are sequentially displayed on a display device according to a predetermined time interval.

(Question Data Display Processing: Steps S300-S302)

The steps S300 through S302 show first processing for display of examination questions. First, a first question data is transmitted from the wireless transmission part 161 in the examination server 16 to the display device 12 at step S300. The transmission timing may mean timing at which the transmission control part 162 detects that the time is the examination starting time, or that input from a user (person who executes the examination) is detected.

Then, at step S302, the display device 12 receives question data in the wireless receiving part 121, and the data is input to the display control part 123. The display control part 123 displays the input question data on the display part 124.

(Answer Data Display Processing: Steps S304-S310)

Steps S304 through S310 are provided for processing in which answer data input from the input device 14 is displayed on the display device 12.

At step S304, data on tracks of the input device 14 by operation of an examinee 11 is input. The data is transmitted to the examination server 16 using the wireless communication unit provided in the input device 14, and is received by the wireless receiving part 164 in the examination server 16 for input to the character recognition part 165. Then, at step S306, the character recognition part 165 performs character recognition of the data on tracks of the input device 14 for extraction of the answer data.

Subsequently, at step S308, the character recognition part 165 stores the extracted answer data in the answer data storing part 166, and transmits the answer data to the display device 12. At step S310, the display device 12 rewrites a part of the display of the display part 124 using the received answer data. Thereby, answer data of each examinee, which is input by the input device 14, is stored in the examination server 16. Moreover, an examinee may confirm an answer, which has been written by the examinee using the input device 14, on the display part 124 in the display device 12.

(Question Data Rewriting Processing: Steps S312-S318)

Steps S312 through S318 indicates processing for rewriting question data displayed on the display device 12.

At step S312, elapsed time after transmission of question data at step S300 is counted in the transmission control part 162 in the examination server 16. Then, elapsed time and a predetermined threshold are compared at step S314. Here, a used threshold is predetermined time for each question data, and indicates time at which a question is indicated on the display device 12. When the elapsed time does not exceed the threshold, the processing returns to step S312, and counting the elapsed time is continued. On the other hand, the processing proceeds to step S314, when the elapsed time exceeds the threshold.

At step S314, the transmission control part 162 obtains question data to be transmitted next from the question data storing part 163, and transmits the data to the display device 12 through the wireless transmission part 161. At step S318, the display device 12 rewrites a part, or all of the displays on the display part 124 by the received question data.

Thus, question data is sequentially transmitted to the display device 12 by control of the examination server 16, and an examinee may sequentially check question data displayed on the display device 12. By the examination server 16 controlling the order in which and time at which question data is transmitted, examination questions may be provided to all examinees at the same time. Accordingly, more equitable provision may be secured. Moreover, as described above, the examination server 16 may transmit question data, based on various kinds of signals input to each of the display devices 12 by operation of an examinee. In this case, each examinee may receive a question responding to own answering speed, and answering order may be freely selected. Therefore, distribution of question data may be adjusted on the side of the examination server 16 according to the styles of examinations.

(Question Data Erasing Processing: Step S320-S324)

Steps S320 through S324 indicate erasing processing of question data displayed on the display device 12.

At step S320, the transmission control part 162 in the examination server 16 judges whether the present time is time for completing an examination. When it is judged that it is not time for completion, the processing returns to step S312. On the other hand, the processing proceeds to step S322 when it is judged that it is time for completion.

At step S322, the transmission control part 162 transmits an erasing signal to the display device 12 through the wireless transmission part 161. Then, at step S324, the display device 12 receives an erasing signal, and the display control part 123 erases the display of the question data on the display part 124.

Here, though the examination server 16 has been configured to erase the display of question data based on certain predetermined time of the time for completing an examination, the examination server 16 may transmit an erasing signal based on other judgment standards. For example, the examination server 16 may transmit an erasing signal, depending on whether the elapsed time after the last question data is transmitted exceeds a predetermined time. Alternatively, the examination server 16 may separately transmit an erasing signal to each of the display devices 12 based on a signal input to each the display devices 12 by operation of an examinee. Moreover, there may be provided a configuration in which a device transmitting an erasing signal is provided at the exit of an examination site, and, when the display device 12 passes through the exit, the device may transmit an erasing signal.

Thus, an examination question may be prevented from flowing out to the outside by erasing the display of the display device along with completion of an examination, even when a display device is taken out. Moreover, the timing for display erasing may be arbitrarily adjusted on the side of the examination server according to the styles of examinations and the like.

As explained above, in the written examination system according to the present embodiment, examination questions may be also prevented from being taken out, because data on the examination questions is not included in the display device distributed to examinees by using the display device only for display of, mainly, examination questions, and by providing data on the displayed examination question and the like from the examination server. Moreover, as the display device is required to be provided with, at least, a display function, there may be reduced the manufacturing cost for display devices the number of which is required to be equal to the number of examinees. Moreover, the power consumption may be reduced because electronic paper is used for the display device.

### Second Embodiment

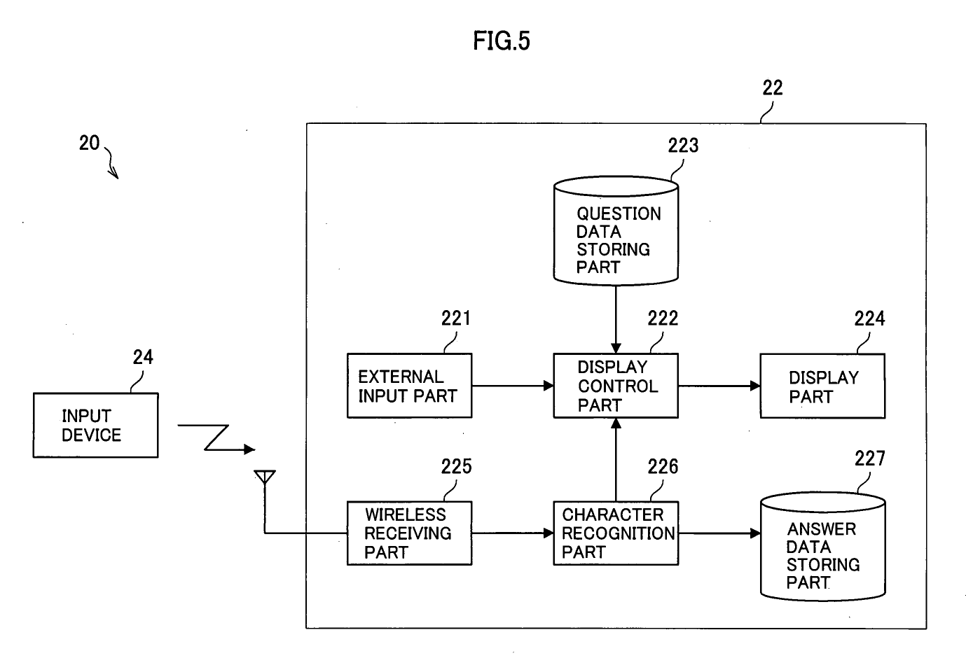

Subsequently, a written examination system according to a second embodiment of the present invention will be explained based on FIG. 5. Here, FIG. 5 is a block diagram showing a schematic configuration of a written examination system 20 according to the second embodiment.

As shown in FIG. 5, a written examination system 20 according to the second embodiment includes: a written examination device 22; and an input device 24. Here, electronic paper is assumed to be used in a representation display used in the written examination device 22 even in the present embodiment.

In the second embodiment, both functions as the examination server and as the display device according to the first embodiment are provided in one device (written examination device 22). Accordingly, the written examination device 22 may have a configuration which is similar to that of the first embodiment, but does not include a communication function between the examination server and the display device according to the first embodiment.

Hereinafter, the configuration of the written examination device 22 will be explained referring to FIG. 5. Here, explanation of the input device 24 according to the present embodiment will be omitted, because the input device 24 has substantially the same functions as those of the input device 14 according to the first embodiment.

(Written Examination Device 22)

The written examination device 22 according to the second embodiment, as well as the display device 12 according to the first embodiment, is distributed to each examinee, and has functions by which examination questions are provided to examinees by a display including electronic paper, and answers input by operation of the input device 24 are displayed on the display. The configuration of the second embodiment is different from that of the first embodiment in a point that the written examination device 22 includes question data within the inside, and controls internally timing for providing examination questions to examinees.

The written examination device 22 includes, as shown in FIG. 5: an external input part 221; a display control part 222; a question data storing part 223; a display part 224; a wireless receiving part 225; a character recognition part 226; and an answer data storing part 227. Repeated explanation for the following parts among the above ones will be omitted, because the external input part 221 has substantially the same function and the same configuration as those of the external input part 122 in the display device 12 according to the first embodiment, the display part 224 has substantially the same function and the same configuration as those of the display device 124 in the display device 12 according to the first embodiment, the question data storing part 223 has substantially the same function and the same configuration as those of the question data storing part 163 in the examination server 16 according to the first embodiment, and, the answer data storing part 227 has substantially the same function and the same configuration as that of the answer data storing part 166 in the examination server 16 according to the first embodiment. Hereinafter, the display control part 222, the wireless receiving part 225, and the character recognition part 226 in the written examination device 22 will be explained.

(Display Control Part 222)

The display control part 222 has functions corresponding to those of the display control part 123 in the display device 12, or the transmission control part 162 in the examination server 16 according to the above-described first embodiment. The display control part 222 obtains question data from the question data storing part 223, displays the question data on the display part 224, and erases the display on the display part 224. Moreover, the display control part 222 may rewrite a part, or all of the contents displayed on the display part 224 according to answer data received by the wireless receiving part 225, and display an answer input by the input device 24 on the display part 224.

Moreover, the display control part 222 may control the display state of the display part 224 according to signals input from the external input part 221. For example, the display control part 222 may display question data on the display part 224, or erase the display, when it is detected that input of a predetermined signal from the external input part 221 is detected.

Moreover, the display control part 222 may internally include a timer for controlling time, and control the display state on the display part 224 according to time counted by the timer. For example, when it is detected by the timer that the examination starting time has come, the display control part 222 may obtain question data from the question data storing part 223, and display on the display part 224. Alternatively, the display may be erased in the case of the examination termination time. Alternatively, elapsed time is counted by the timer after display of certain question data is started, and, when the elapsed time exceeds predetermined elapsed time, the display control part 222 rewrite the display by the next question data.

(Wireless Receiving Part 225)

The wireless receiving part 225 is corresponding to the wireless receiving part 164 in the examination server 16 according to the above-described first embodiment to receive data transmitted from the input device 24. The wireless receiving part 225 receives handwriting data transmitted from the input device 24, and inputs the data to the character recognition part 226.

(Character Recognition Part 226)

The character recognition part 226 has substantially the same function and the same configuration as those of the character recognition part 165 in the examination server 16 according to the above-described first embodiment except inputting extracted answer data to the display control part 222.

As described above, the configuration of the written examination device 22 has been explained. Here, there may be provided a configuration in which the external input part 221, the display control part 222, the wireless receiving part 225, and the character recognition part 226 may be configured by software including program modules which may execute the above described functions and are installed in the information processing device such as computers, or by hardware such as processors which may execute the above-described functions. Moreover, the question data storing part 223, and the answer data storing part 227 may include various kinds of storage media such as a semiconductor memory, an optical disk, and a magnetic disk.

In the case of the configuration according to the second embodiment, the configuration may be made simple in comparison with that of the first embodiment, because the function of the examination server and that of the display device may be included in the written examination device, and the relay device and the like between the examination server and the display device are not required. Communication is not generated every time the question data is rewritten, so that there is an advantage that there are hardly generated problems even in rewriting response.

As explained above, paper consumption may be reduced, and, furthermore, electric power consumption may be also reduced by using electronic paper instead of a question sheet. Moreover, paper consumption may be further reduced by not using paper even for writing answers, and but by displaying the answers on electronic paper. Moreover, the display of questions may be surely erased by transmitting a signal for erasing the display from the outside to the electronic paper, so that an examination question may be prevented from being taken out to the outside.

As described above, preferable embodiments according to the present invention have been explained referring to attached drawings, but the present invention is not obviously limited to the above-described examples. Various kinds of modifications and applications may obviously occur to those skilled in the art within the scope of the invention as defined in the appended claims, and it will be obviously understood that the modifications and the applications belong to the technical scope of the present invention.

Though, it has been explained, for example, in the above-described embodiments, that the display device has both functions, that is, a function for displaying examination questions, and providing to examinees, and a function for displaying answers input through the input device on the display screen, the present invention is not limited to the above-described examples. There may be provided, for example, a configuration in which a display device having a function displaying examination questions, and a display device having a function displaying answer contents are separately provided in a physical manner.

What is claimed is:

1. A written examination system comprising a display device used by each of examinees taking a written examination, and an information processing device providing examination question data to the display device, wherein
the display device includes:
a display part including electronic paper on which the examination question data is displayed;
a receiving part for receiving the examination question data transmitted from the information processing device; and
a display control part for displaying the examination question data received by the receiving part on the display part, and controlling the display state of the display part, and
the information processing device includes:
a question data storing part for storing the examination question data; and
a transmission control part for reading out the examination question data from the question data storing part, and controlling transmission of the examination question data to the display device.

2. The written examination system as claimed in claim 1, wherein the transmission control part counts elapsed time after the examination question data is transmitted to the display device, and, reads out the examination question data different from the examination question data under displaying from the question data storing part and transmits to the display device, when the elapsed time exceeds a predetermined value.

3. The written examination system as claimed in claim 1, wherein the display device further includes an external signal input part into which an external signal for changing a display state of the display device is input, and the display control part displays the examination question data different from the examination question data under displaying on the display part according to the external signal input to the external signal input part.

4. The written examination system as claimed in claim 1, wherein the transmission control part transmits a signal for erasing the display of the examination question data to the display device at predetermined time.

5. The written examination system as claimed in claim 3, wherein the display control part erases the display of the display part according to the external signal input from the external signal input part.

6. The written examination system as claimed in claim 1 further comprising:
an answer input device used for input of answer data indicating the contents answered by an examinee, wherein
the display device receives the answer data input by the answer input device, and the answer data is displayed on the display part.

7. The written examination system as claimed in claim 6, wherein
the information processing device further including:
a receiving part for receiving the answer data input by the answer input device;
a character recognition part for performing character recognition processing of the answer data received by the receiving part; and
an answer storing part for storing the answer data for each of the examinees, wherein
the character recognition part stores data, which includes characters recognized by the character recognition part, as answer data in the answer storing part.

8. A written examination device used by each of examinees taking a written examination, comprising:
a question data storing part for storing examination question data;
a display part including electronic paper on which the examination question data is displayed; and
a display control part for reading out the examination question data from the question data storing part, displaying the examination question data on the display part, and controlling the display state of the display part.

9. The written examination device as claimed in claim 8, wherein the display control part counts elapsed time after an arbitrary piece of the examination question data is displayed on the display part, and, reads out the examination question data different from the examination question data under displaying from the question data storing part and displays on the display part when the elapsed time exceeds a predetermined value.

10. The written examination device as claimed in claim 8, further comprising
an external signal input part into which an external signal for changing the display state of the display part is input, wherein
the display control part reads out the examination question data different from the examination question data under displaying from the question data storing part and displays on the display part, according to the external signal input from the external signal input part.

11. The written examination device as claimed in claim 8, wherein the display control part erases the display of the display part at predetermined time.

12. The written examination device as claimed in claim 10, wherein the display control part erases the display of the display part according to the external signal input from the external signal input part.

13. The written examination device as claimed in claim 8, further comprising:
an answer input part into which answer data indicating the contents answered by an examinee is input; and
an answer storing part for storing the answer data input from the answer input part for each of the examinees, wherein
the display control part displays the answer data input from the answer input part on the display part.

14. The written examination device as claimed in claim 13, further comprising
a character recognition part for performing character recognition processing of the answer data input into the answer input part, wherein
the character recognition part stores data including characters recognized by the character recognition part as answer data in the answer storing part.
